(19) United States
(12) Patent Application Publication
(10) Pub. No.: US 2020/0265732 A1
(43) Pub. Date: Aug. 20, 2020

(54) REALISTIC BLOCK-GAME EDUCATIONAL DEVICE USING SOUND COMBINATION PRINCIPLES, AND CONTROL METHOD OF SAME

(71) Applicant: DH-EBIZ CO., LTD., Incheon (KR)

(72) Inventors: Soon Ho HWANG, Seoul (KR); Kil Jung KIM, Seoul (KR); Ji Suk YOON, Seoul (KR); Yong Ho KIM, Seoul (KR)

(21) Appl. No.: 16/651,534

(22) PCT Filed: Sep. 21, 2018
(86) PCT No.: PCT/KR2018/011239

§ 371 Date: Mar. 27, 2020

(30) Foreign Application Priority Data
Sep. 29, 2017 (KR) 10-2017-0128317
Nov. 29, 2017 (KR) 10-2017-0161850

(51) Int. Cl. G09B 1/16; G09B 5/06; A63F 9/00

(52) U.S. Cl. CPC G09B 1/16; A63F 9/0098; G09B 5/06

(57) ABSTRACT

Embodiments provide a realistic block-game educational device using sound combination principles and a control method of the same.

### TECHNICAL FIELD

Exemplary embodiments relate to a realistic block-game educational device using sound combination principles and a control method of the same, and more particularly, to a realistic block-game educational device using sound combination principles suitable for phonics learning and a control method of the same.

The present application claims the benefit of Korean Patent Application No. 10-2017-0128317 filed on Sep. 29, 2017 and Korean Patent Application No. 10-2017-0161850 filed on Nov. 29, 2019 with the Korean Intellectual Property Office, the disclosure of which is incorporated herein by reference in its entirety.

### BACKGROUND ART

A block set, in particular, a block set designed after Alphabet or Hangul consonants and vowels is widely used for playing or learning. Particularly, it is usually used for children in households, kindergartens or language institutes or people who want to learn new languages.

A block set user can improve the spatial perception ability by combining or matching blocks included in the block set. Particularly, in the case of the block set designed after Alphabet or Hangul consonants and vowels, the user can learn basic letters by combining blocks.

However, when the user arbitrarily combines blocks, unless the user has already known or is taught by somebody, the user cannot easily know if the combination is a possible combination or the combined block arrangement is correct.

Phonological awareness is the ability to divide a spoken language into words, divide the word into syllables, divide the syllable into onset and rime, and even into phoneme, i.e., smallest units that cannot be separated any longer. In phonological awareness, “phonemic awareness” is the ability to recognize a phoneme which is a smallest unit of sound, and separate, identify, sort, combine, segment and delete sound (phoneme). Alphabet letters spelling symbolizes sound at the phoneme level, and to obtain the effect of teaching reading, a learner needs to recognize phonemes to some extent, and because teaching reading also develops the learner's ability to recognize phonemes, phoneme recognition is the prerequisite and result of reading learning.

Phonics is a combined word of phone (sound) and -nics (study), and is language educational terminology that originally refers to a relationship between pronunciation and spelling in any language and teaching it. It is a phonics method that teaches a method of associating phoneme and grapheme, and may be classified into synthetic phonics, Analytic Phonics, phonics teaching through spelling, context-based phonics teaching and inferential phonics, according to the way to deal with phonemes in a word.

The synthetic phonics is a method of explicitly teaching a relationship between phoneme and grapheme, which first teaches all phonemes, i.e., smallest units of word, that is to say, sounds of each letter, and then builds up to blending these sounds together to achieve full pronunciation of whole words.

### DISCLOSURE

### Technical Problem

Embodiments provide a realistic block-game educational device using sound combination principles and a control method of the same.

### Technical Solution

A realistic block-game educational device using sound combination principles according to an embodiment includes a board on which a plurality of sensors for recognizing blocks are arranged in a grid, a plurality of blocks which are arranged on the board, each showing a sound combination principle, and a control unit which when at least one of the plurality of blocks is arranged on the board, recognizes the block arranged on the board, extracts sound corresponding to the recognized block, and outputs the extracted sound, wherein when at least two of the blocks are arranged on the board, the control unit senses a distance between the arranged blocks, and adjusts an output time difference of each extracted sound according to the sensed distance.

When the distance between the at least two blocks is equal to or less than a first threshold, the control unit may extract a third sound corresponding to a combination of each block, and output the extracted third sound.

The control unit may sense the distance between the arranged blocks according to sensing values from the plurality of sensors.

The plurality of blocks may include consonant and vowel blocks suitable for phonics learning.

The plurality of blocks may include a consonant, a vowel and a combination of at least one consonant and at least one vowel

When any one of the at least two blocks is arranged outside a horizontal axis of the board, or the block arranged on the board is not recognized, the control unit may output an error signal.

A control method of a realistic block-game educational device using sound combination principles according to another embodiment, in which the device comprises a board on which a plurality of sensors for recognizing blocks are arranged in a grid, a plurality of blocks which are arranged on the board, each showing a sound combination principle, and a control unit, the control method includes when at least one of the plurality of blocks is arranged on the board, recognizing the block arranged on the board, extracting sound corresponding to the recognized block, and outputting the extracted sound, and when at least two of the blocks are arranged on the board, sensing a distance between the arranged blocks, and adjusting an output time difference of each extracted sound according to the sensed distance.

A recording medium according to still another embodiment has recorded therein a program for performing the control method on a computer.

### Advantageous Effects

According to the disclosed embodiments, it is possible to recognize the type of block or combinations of blocks and output the recognized result. Additionally, when at least two blocks of the block set are combined, it is possible to automatically recognize if the combination is a possible combination or the combined block arrangement is correct and output the recognized result through sound or other means. Additionally, it is possible to achieve interactive learning through the user's visual, auditory and tactic senses, and improve the user's spatial perception ability and creativity.

Additionally, it is possible to improve the language ability related to the left brain through language learning and the spatial perception ability and creativity related to the right brain through block-game, thereby stimulating the user's the left brain and the right brain at the same time. Additionally, it is possible to achieve user centered learning.

Additionally, in phonics learning, even a word that does not exist in English dictionaries, it is possible to allow a learner to combine and arrange phonemes, i.e., the smallest units of sound at his/her discretion, thereby increasing the degree of freedom.

Additionally, individual phonemes of blocks may be recognized first, the phonics principles may be recognized through blending activities of blocks arrangement. combination, sound may be differentially recognized according to the position at which individual phonemes are sequentially arranged, and sound of combined phonemes of a combination of blocks with changes in block position may be recognized, so it is easy to effectively understand the principle of sound combination.

### BRIEF DESCRIPTION OF DRAWINGS

FIG. 1 is a schematic diagram of the outward shape of a realistic block-game educational device 100 according to an embodiment.

FIGS. 2A to 2C are exemplary diagrams of blocks included in the device 100 shown in FIG. 1.

FIG. 3 is a detailed block diagram of the device 100 shown in FIG. 1.

FIG. 4 is an exemplary diagram of a storage unit shown in FIG. 1.

FIGS. 5A to 5G are exemplary diagrams illustrating sound output based on block combination according to another embodiment.

FIGS. 6A to 6C are exemplary diagrams illustrating sound output based on block combination according to still another embodiment.

FIGS. 7A to 7C are exemplary diagrams illustrating error signal output based on block combination according to yet another embodiment.

FIG. 8 is an exemplary diagram illustrating sound output based on block combination according to further another embodiment.

FIGS. 9 and 10 are flowcharts illustrating a control method of a realistic block-game educational device according to still further another embodiment.

### MODE FOR DISCLOSURE

Hereinafter, the embodiments of the present disclosure will be described in detail with reference to the accompanying drawings. However, the accompanying drawings are illustrated to provide an easy understanding of the present disclosure, and those skilled in the art will easily understand that the scope of the present disclosure is not limited to the scope of the accompanying drawings.

Additionally, throughout the specification, it will be further understood that when an element is referred to as being “connected to” another element, it can be directly connected to the other element or intervening elements may be present. Additionally, unless the context clearly indicates otherwise, it will be understood that the term “comprises” or “includes” when used in this specification, specifies the presence of stated elements, but does not preclude the presence or addition of one or more other elements.

Phonics block recognition according to an embodiment may be performed by recognizing a block made in the form of phonics phoneme through sensors provided in a block board, or presenting an ID for phonics phoneme recognition on the back of the block and recognizing the block.

Block recognition may include a board and an output unit, and the board may include a plurality of convex portions periodically arranged at a grid-shaped intersection area, and a plurality of grooves periodically arranged at a grid-shaped central area. Sensors are placed on the back of the plurality of grooves to detect if the groove is hidden by the block. Here, the sensor may be a proximity sensor, and the proximity sensor may include, but is not limited to, an infrared proximity sensor, a hall sensor and a capacitive sensor. Additionally, the sensors may be placed over the plate, or on the back of each of the plurality of grooves. Block recognition may be implemented in various forms.

Other conventional language textbooks or tools display letters, most of which are based on words present in English dictionaries, and it is general to see the words by eyes, write them or match blocks. For example, a learner learns a common pattern of the smallest unit of sound ‘¬’ when learning words ‘ [symbol] / [symbol] / [symbol] / [symbol] ’ printed on a textbook in a sequential order.

Taking English as an example, when learning bat/mat/rat/cat′ printed on a textbook, a learner learns the smallest units of sound ‘a’ and ‘t’ by learning a common pattern ‘at’.

A realistic block-game device and method according to an embodiment may provide freedom that allows a learner to combine and arrange the smallest units of sound at his/her discretion. Particularly, it is possible to allow a learner to make up even a word that does not exist in the existing English dictionaries, for example, a nonsense word and practice reading it based on the phonics rule.

There are about 44 sounds including 26 English Alphabet letters A-Z and even double consonants, and each sound is provided in the form of a block. When the learner combines the blocks and moves them to the block board, the placed blocks are recognized and the sound is outputted.

The device according to an embodiment builds a database of about 4 to 5,000 possible combinations of consonant-vowel-consonant in the structure of basic phonics learning, and outputs the sound according to the arrangement the learner places.

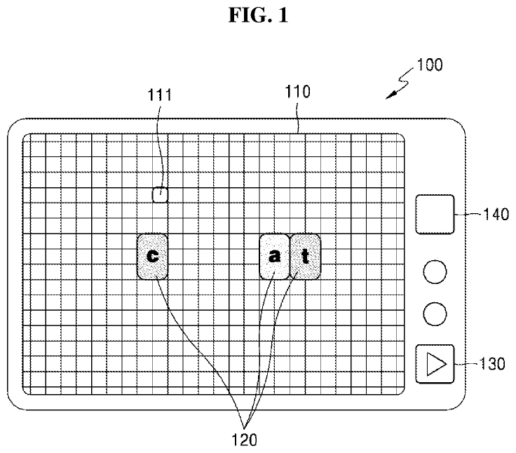

FIG. 1 is a schematic diagram of the outward shape of the realistic block-game educational device 100.

Referring to FIG. 1, the realistic block-game educational device 100 includes a board 110 on which blocks 120 are placed, and a plurality of sensors 111 placed at the center in a grid on the board 110. The blocks 110 placed on the board 110 are recognized through a user selection button 130 and an audio output unit 140, and sound corresponding to the recognized block is outputted through the audio output unit 140. Although not shown, the realistic block-game educational device 100 may further include a light emitting device to display the block, and a light emitting device to output an error signal.

The realistic block-game educational device 100 according to an embodiment may apply various methods to recognize the block. For example, the various methods include recognizing the shape of block displaying English or Hangul using the sensor, or presenting a structural ID on the back of the block and recognizing it through the sensor, etc.

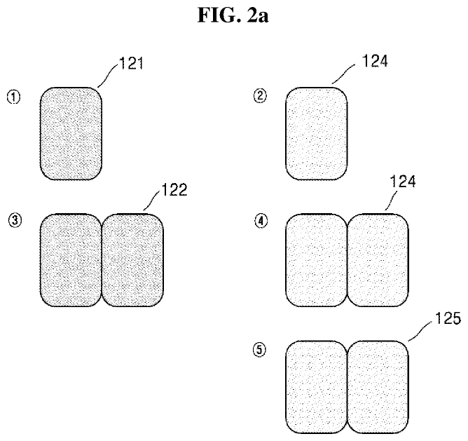

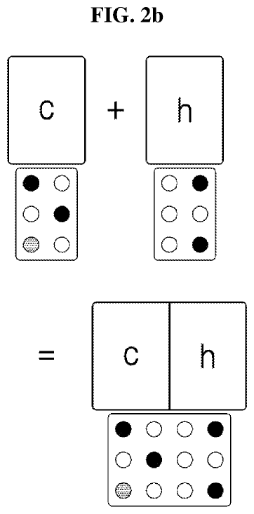

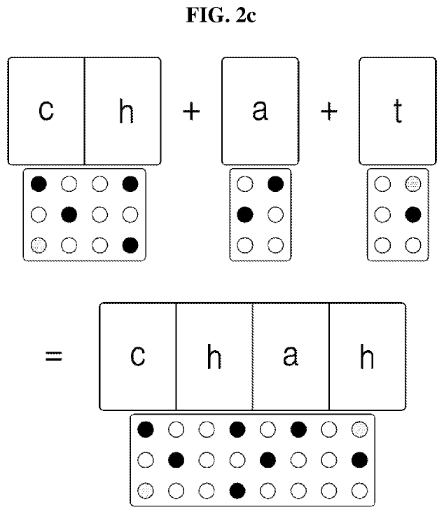

Examples of the blocks will be described below with reference to FIGS. 2A to 2C.

The plurality of sensors 111 may be arranged at a regular interval on the board 110, the sensor may be a proximity sensor, and the proximity sensor may include, but is not limited to, an infrared proximity sensor, a hall sensor and a capacitive sensor. Additionally, the distance between the blocks placed on the board 110 may be determined through the position at which the sensors are arranged.

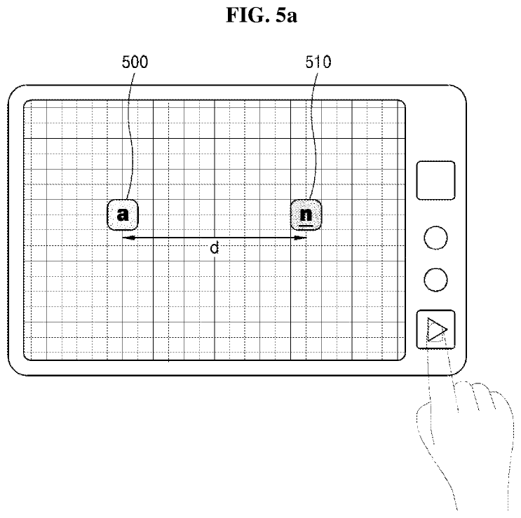

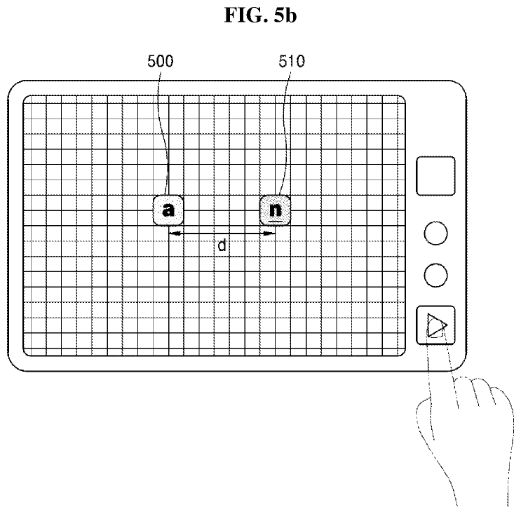

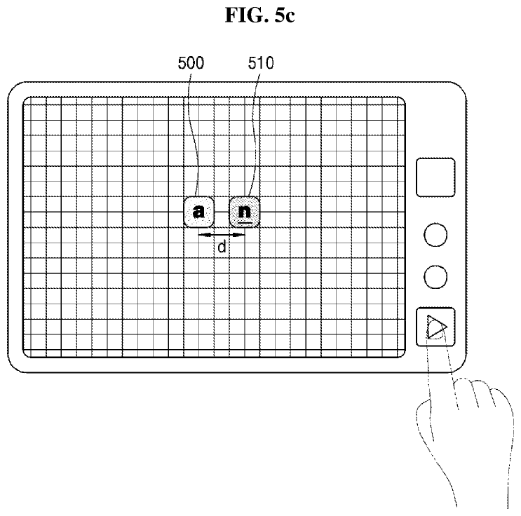

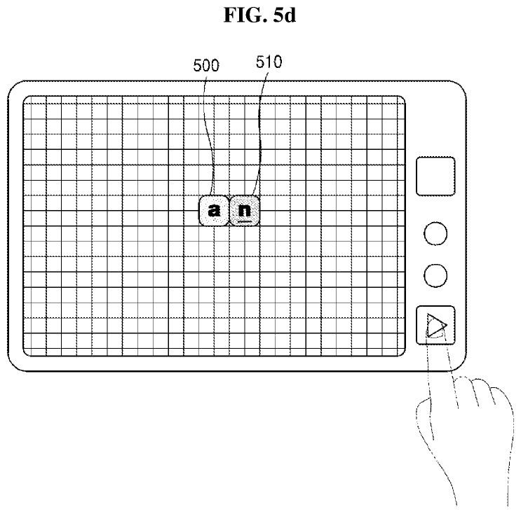

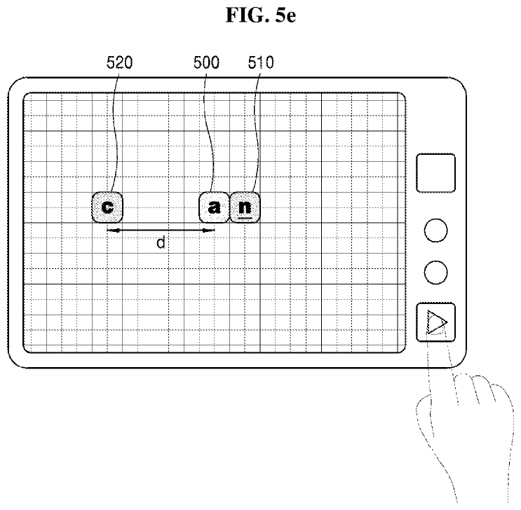

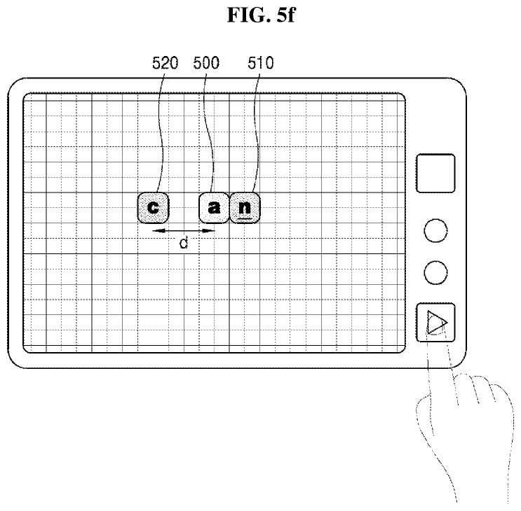

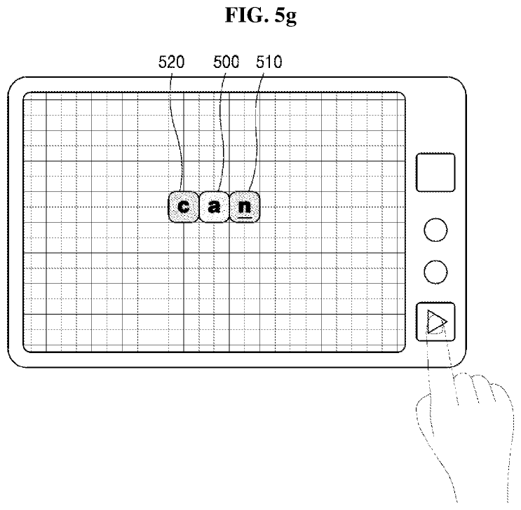

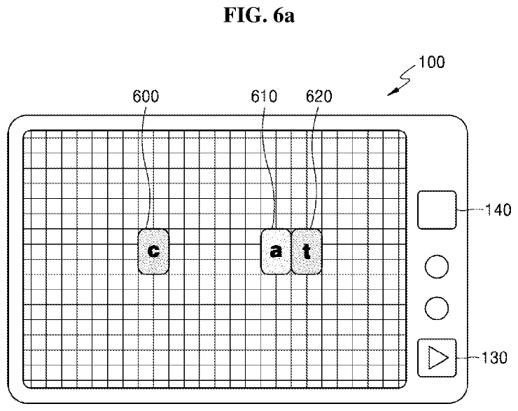

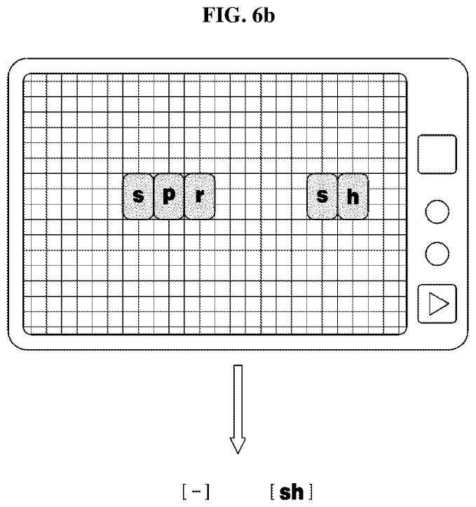

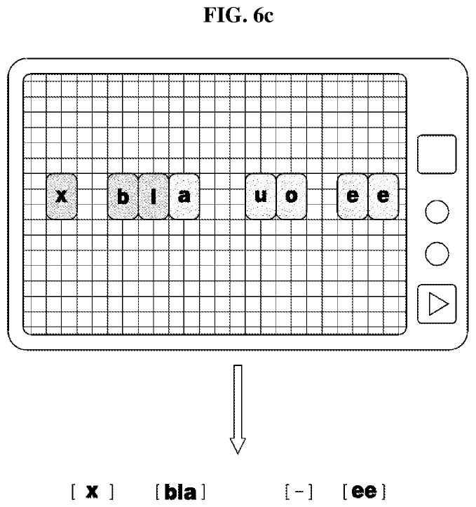

When two or more blocks are arranged on the board, the realistic block-game educational device 100 according to an embodiment may sense the distance between the arranged blocks, and adjust an output time difference of each extracted sound according to the sensed distance. For example, as shown in FIG. 1, Alphabet c block may be recognized, sound “ [symbol] ” corresponding to the recognized block may be outputted, and after a delay as much as the distance between each block, sound “ [symbol] ” of a combination of the a block and the t block may be outputted. The adjustment of the output time difference according to the distance between blocks will be described below with reference to FIGS. 5 and 6.

FIGS. 2A to 2C are exemplary diagrams of the blocks included in the device 100 shown in FIG. 1.

Referring to FIG. 2A, the device 100 may include consonant blocks 121 and 122 and vowel blocks 123 to 125. Here, the consonant block and the vowel block may be distinguished by color, and blocks used for phonics learning may be configured as below. The consonant block 121 may include 21 blocks including b c d f g h j k l m n p q r s t v w x y z, and the consonant block 122 which is a block of two phonemes in combination may include 22 blocks including bl cl fl gl pl br cr dr fr pr tr sl sm sn st mp th sh ch ck nk ng.

The vowel block 123 may include 5 blocks including a e i o u, the vowel block 124 may include 10 blocks including ee ea oo ou oa ai of ow ay oy, and the vowel block 125 may include 4 blocks including ar er it or.

Although the embodiment is described taking the consonant and vowel blocks used in phonics English learning as an example, the present disclosure is not limited thereto, and the same may be applied to Hangul blocks or blocks used in other language learning.

The realistic block-game educational device 100 according to an embodiment may be applied to ABC phonics or blending phonics, and is effective in understanding the principles of phonics through the practice of learning each sound of 26 Alphabet letters in total and combining words in CVC pattern by combining basic sounds.

Referring to FIG. 2B, it shows the output of a third sound, i.e., consonant blends “ch”, into which two consonants are combined. As shown in FIG. 2B, each consonant block has each ID on the back to recognize an output sound of each block, and when the two blocks are combined, a third ID into which each ID is combined may be recognized and a third sound may be outputted.

Referring to FIG. 2C, when the generated “ch” is combined with a different sound, a fourth sound “chat” is outputted. That is, IDs may be grouped and recognized as a fourth ID and a fourth sound may be outputted.

In this way, as IDs continuously change according to the number of possible combinations, different sounds may be outputted.

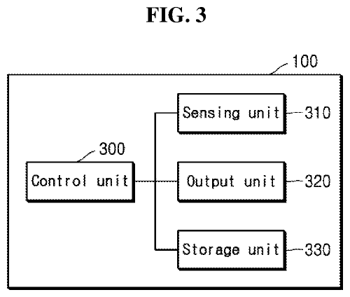

FIG. 3 is a detailed block diagram of the device 100 shown in FIG. 1.

Referring to FIG. 3, the device 100 includes a control unit 300, a sensing unit 310, an output unit 320 and a storage unit 330.

The sensing unit 310 recognizes a block through a plurality of sensors regularly arranged in a grid on the board 110, and recognizes the position at which the block is placed.

The output unit 320 outputs a result of sensing by the sensing unit 310, for example, sound corresponding to the block. The output unit 320 may be a speaker, but is not limited thereto.

The storage unit 330 stores the sound that matches the block.

When an arbitrary block of a plurality of blocks is arranged on the board, the control unit 300 recognizes the block arranged on the board, extracts sound corresponding to the recognized block from the storage unit 330, and outputs the extracted sound through the output unit 320. Additionally, when two or more blocks are arranged on the board, the control unit 300 senses the distance between the arranged blocks, and adjusts an output time difference of each extracted sound according to the sensed distance. For example, when the blocks are in contact with each other or they are arranged apart one spacing, the control unit 300 extracts a combined sound of the two blocks, not sound of each block. The control unit 300 may sense the distance between the arranged blocks according to sensing values from the plurality of sensors. Additionally, the output time difference may be adjusted to a sound source interval of 0.15 sec per block spacing.

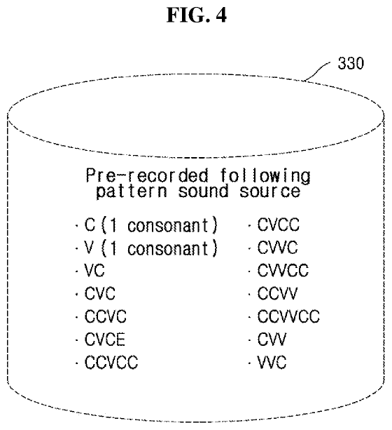

FIG. 4 is an exemplary diagram of the storage unit shown in FIG. 1.

The storage unit 330 stores sounds corresponding to phonics phonemes to match blocks. For example, as shown in FIG. 4, the storage unit 330 may store C (1 consonant), V (1 vowel), CV, VC, CVC, CCVC, CVCE, CCVCC, CVCC, CVVC, CVVCC, CCVV, CCVVC, CCVVCC, CVV, VVC.

The control unit 300 recognizes blocks placed on the board, and extracts and outputs sound matching to the blocks recognized by the storage unit 330.

FIGS. 5A to 5G are exemplary diagrams illustrating sound output based on block combination according to another embodiment.

Referring to FIG. 5A, when an Alphabet a block 500 and an n block 510 are arranged on the board, the a block 500 is recognized, a distance d is recognized, and the n block 510 is recognized. In this instance, when a user selection unit is selected, sound of “a” corresponding to the a block 500 is outputted, and when the distance d is five block spacing, sound of “n” corresponding to the n block 510 is outputted in 0.75 sec.

Referring to FIG. 5B, when the distance between the two blocks is closer, sound of “a” corresponding to the a block 500 is outputted, and when the distance d is three block spacing, sound of “n” corresponding to the n block 510 is outputted in 0.45 sec.

Referring to FIG. 5C, when the distance between the two blocks is much closer, sound of “a” corresponding to the a block 500 is outputted, and when the distance d is one block spacing, sound of “n” corresponding to the n block 510 is outputted in 0.15 sec.

Referring to FIG. 5D, when the two blocks are combined together or come into contact with each other, sound of “an” corresponding to the a block 500 and the n block 510 is outputted.

As described with reference to FIGS. 5A to 5D, it is possible to learn each phoneme, and allow the user to freely learn sound of a combination of each phoneme.

As shown in FIGS. 5E to 5F, when a c block 520 is added, sound of “c” corresponding to the c block 520 and sound of “an” corresponding to the combination of the a block 500 and the n block 510 are outputted, and in FIG. 5f, when the blocks are combined, corresponding sound of “can” is outputted.

FIGS. 6A to 6C are exemplary diagrams illustrating sound output based on block combination according to still another embodiment.

As shown in FIGS. 6A to 6C, because spr block and uo block are not pronunciation that exists in phonics, they may be silent processed.

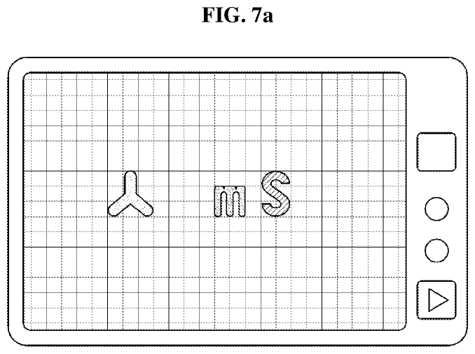

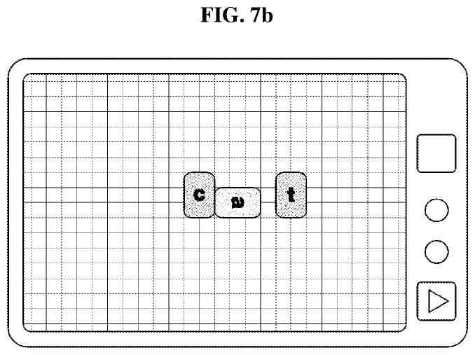

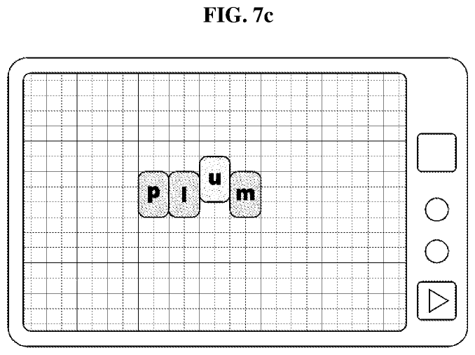

FIGS. 7A to 7C are exemplary diagrams illustrating error signal output based on block combination according to yet another embodiment.

When blocks other than phonics blocks are arranged on the board as shown in FIG. 7A, phonics blocks are arranged 90° to 180° as shown in FIG. 7B, or any one of the phonics blocks is arranged outside the horizontal axis, an error signal, for example, a disable effect sound or a message notifying that re-arrangement is required may be outputted.

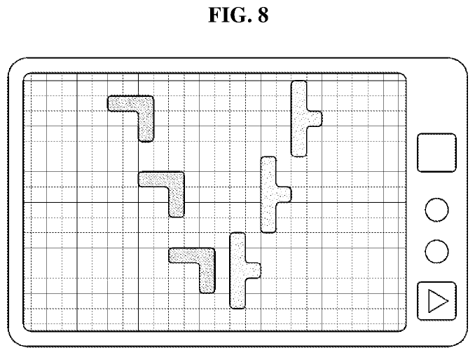

FIG. 8 is an exemplary diagram illustrating sound output based on block combination according to further another embodiment.

Referring to FIG. 8, phonics learning may be applied to Hangul consonant and vowel blocks by the same principle. When ¬ block and ├ block are arranged, their corresponding sounds, “ [symbol] ” and “ [symbol] ” are outputted at a distance difference between each block arranged. When ¬ block and ├ block are arranged within a predetermined distance, sound of “ [symbol] ” corresponding to the combination is outputted.

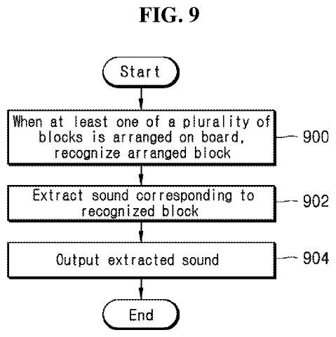

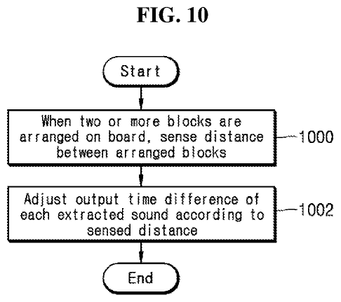

FIGS. 9 and 10 are flowcharts illustrating a control method of the realistic block-game educational device according to still further another embodiment.

Referring to FIG. 9, in step 900, when at least one of the plurality of blocks is arranged on the board, the arranged block is recognized.

In step 902, sound corresponding to the recognized block is extracted.

In step 904, the extracted sound is outputted.

Referring to FIG. 10, when two or more blocks are arranged on the board, a distance between the arranged blocks is sensed.

In step 1002, an output time difference of each extracted sound is adjusted according to the sensed distance.

Accordingly, the device according to an embodiment recognizes the phonemes of the corresponding blocks, as well as the position at which they are placed on the block board, and adjusts the audio output time. For example, as shown in FIGS. 2 to 5, each phoneme may be outputted at a time interval according to the distance between two blocks, and when two blocks are placed in close contact, phoneme of a combination of the two blocks is outputted.

Additionally, it is possible to recognize and output even a word that does not exist in the world such as vem. Because phonics can create sound by combination, it is different from the existing block type tool for learning only words that exist in English dictionaries.

According to the embodiment hereinabove described, it is possible to recognize the type of block or combinations of blocks and output the recognized result. Additionally, when at least two blocks of the block set are combined, it is possible to automatically recognize if the combination is a possible combination or the combined block arrangement is correct and output the recognized result through sound or other means. Additionally, it is possible to achieve interactive learning through the user's visual, auditory and tactic senses, and improve the user's spatial perception ability and creativity. Additionally, it is possible to improve the language ability related to the left brain through language learning and the spatial perception ability and creativity related to the right brain through block-game, thereby stimulating the user's the left brain and the right brain at the same time. Additionally, user centered learning may be achieved.

While the present disclosure has been hereinabove described with regard to the embodiments of the present disclosure, this is for illustration only and is not intended to limit the present disclosure, and those having ordinary skill in the field pertaining to the present disclosure will understand that many modifications and variations may be made without departing from the essential feature of the embodiments of the present disclosure. For example, each component described in the embodiments of the present disclosure may be embodied in modified forms. Additionally, differences related to such modifications and variations should be interpreted as falling within the scope of the present disclosure defined in the appended claims.

The above-descried embodiments may be written in programs executable by the computer, and implemented in universal digital computers that run the programs using the computer-readable media. Additionally, the structure of data used in the above-descried embodiments may be recorded in computer-readable media through many means. Additionally, the above-descried embodiments may be implemented in the form of recording media including instructions executable by the computer such as program modules executable by the computer. For example, methods implemented in software modules or algorithms are codes or program instructions readable and executable by the computer and may be stored in computer-readable recording media.

The computer-readable media may be any recording media accessible by the computer, and may include volatile and non-volatile media, removable and non-removable media. The computer-readable media may include storage media such as magnetic storage media, for example, including ROM, floppy disk, hard disk, etc., optically readable media, for example, CD-ROM, DVD, but is not limited thereto. Additionally, the computer-readable media may include computer storage media and communication media.

Additionally, the computer-readable recording media may be distributed over computer systems connected via a network, and data, for example, program instructions and codes, stored in the distributed recording media may be executed by at least one computer.

Specific executions described herein are just an embodiment, but not intended to limit the scope of the present disclosure. For clarity of description, descriptions of conventional electronic components, control systems, software, and other functional aspects of the systems may be omitted herein.

The above description of the present disclosure is for illustration only, and those having ordinary skill in the technical field pertaining to the present disclosure will easily understand that the present disclosure may be easily modified in other specific forms without changing the technical aspect or essential feature of the present disclosure. Therefore, the embodiments hereinabove described should be understood as being illustrative, not limiting, in all aspect. For example, each component described in single forms may be embodied in distributed manner, and likewise, components described as distributed may be embodied in combined form.

Those having ordinary skill in the technical field related to the embodiments of the present disclosure will understand that the present disclosure may be implemented in modified form without departing from the essential feature of the present disclosure.

The present disclosure may have various modification and many embodiments, and it should be understood that the present disclosure is not limited to a specific embodiment described herein, and covers all modifications, equivalents and substitutions included in the aspect and technical scope of the present disclosure. The disclosed embodiments should be understood from the descriptive perspective, not limitative perspective.

The scope of the present disclosure is defined by the appended claims rather than the detailed description, and it should be interpreted that the scope of the present disclosure covers all changed or modified forms derived from the meaning and scope of the appended claims and their equivalent concept.

The term “unit” and “module” as used herein refers to a processing unit of at least one function or operation, and may be implemented as hardware or software alone or in combination.

The “unit” and “module” may be stored in addressable storage media and implemented by programs executable by the processor. For example, “unit” and “module” may be implemented as components such as software components, object oriented software components, class components and task components, processes, functions, attributes, procedures, subroutines, segments of program codes, drivers, firmware, microcodes, circuits, data, database, data structures, tables, arrays and variables.

1-10. (canceled)

11. A realistic block-game educational device using sound combination principles, the realistic block-game educational device comprising:
a board on which a plurality of sensors for recognizing blocks are arranged in a grid;
a plurality of blocks which are arranged on the board, each showing a sound combination principle; and
a control unit which when at least one of the plurality of blocks is arranged on the board, recognizes the block arranged on the board, extracts sound corresponding to the recognized block, and outputs the extracted sound,
wherein when at least two of the blocks are arranged on the board, the control unit senses a distance between the arranged blocks, and adjusts an output time difference of each extracted sound—the each extracted sound including a first sound and a second sound—according to the sensed distance,
when the distance between the at least two blocks is equal to or less than a first threshold, the control unit extracts a third sound corresponding to a combination of each block—the third sound is a dictionary pronunciation of a word when phonemes preset to each block are combined together, or where there is no dictionary pronunciation, a combination sound according to a phonics rule—and outputs the extracted third sound, and
an ID is given on back of each block to recognize the phonics phonemes.

12. The realistic block-game educational device according to claim 11, wherein the control unit senses the distance between the arranged blocks according to sensing values from the plurality of sensors.

13. The realistic block-game educational device according to claim 11, wherein the plurality of blocks includes consonant and vowel blocks for phonics learning.

14. The realistic block-game educational device according to claim 13, wherein the plurality of blocks includes a consonant, a vowel and a combination of at least one consonant and at least one vowel

15. The realistic block-game educational device according to claim 11, wherein when any one of the at least two blocks is arranged outside a horizontal axis of the board, or the block arranged on the board is not recognized, the control unit outputs an error signal.

16. A control method of a realistic block-game educational device using sound combination principles, in which the device comprises a board on which a plurality of sensors for recognizing blocks are arranged in a grid, a plurality of blocks which are arranged on the board, each showing a sound combination principle, and a control unit, the control method of a realistic block-game educational device comprising:
when at least one of the plurality of blocks is arranged on the board, recognizing the block arranged on the board;
extracting sound corresponding to the recognized block; and
outputting the extracted sound, and
when at least two of the blocks are arranged on the board, sensing a distance between the arranged blocks; and
adjusting an output time difference of each extracted sound—the each extracted sound including a first sound and a second sound—according to the sensed distance,
when the distance between the at least two blocks is equal to or less than a first threshold, extracting a third sound corresponding to a combination of each block—the third sound is a dictionary pronunciation of a word when phonemes preset to each block are combined together, or where there is no dictionary pronunciation, a combination sound according to a phonics rule—and outputting the extracted third sound, and
an ID is given on back of each block to recognize the phonics phonemes.

17. The control method of a realistic block-game educational device according to claim 16, wherein sensing the distance between the arranged blocks according to sensing values from the plurality of sensors.

18. A recording medium having recorded therein a program for implementing the method according to claim 16 on a computer.

19. A recording medium having recorded therein a program for implementing the method according to claim 17 on a computer.
